(19) United States
(12) Patent Application Publication
(10) Pub. No.: US 2010/0211333 A1
(43) Pub. Date: Aug. 19, 2010

(54) Leak Detection and Identification System

(75) Inventors: Richard T. Pruet, Houston, TX (US); Christopher Cotton, Honeoye Falls, NY (US)

Correspondence Address: BAKER & MCKENZIE LLP, 711 Louisiana, Suite 3400, HOUSTON, TX, 77002, US

(73) Assignee: Integrated Process Resources, Inc., Houston, TX (US)

(21) Appl. No.: 12/687,055

(22) Filed: Jan. 13, 2010

Related U.S. Application Data
(60) Provisional application No. 61/144,689, filed on Jan. 14, 2009.

(51) Int. Cl. G01F 23/284

(52) U.S. Cl. 702/51; 356/519

(57) ABSTRACT

A leak detection and identification system a Fabry-Perot etalon, an imaging lens, a microbolometer camera, and a computer for spectral and image data post-processing, wherein the data peaks are deconvoluted for use thus avoiding the need for bandpass filters.

### CROSS REFERENCE TO RELATED APPLICATIONS

This application claims priority to U.S. Provisional Application No. 61/144,689, filed Jan. 14, 2009 and incorporated by reference in its entirety.

### FEDERALLY SPONSORED RESEARCH

Not applicable.

### REFERENCE TO MICROFICHE APPENDIX

Not applicable.

### FIELD OF THE INVENTION

A system for inspecting equipment for potential leaks, more specifically, a handheld optical imaging device that detects and identifies leaks in near real time.

### BACKGROUND OF THE INVENTION

Unintended or “fugitive” gas emissions cost billions of dollars in regulatory fines and damages, pose deadly risks to both workers and people living close to refinery and manufacturing facilities, and are a major contributor to global warming. Leak Detection and Repair (LDAR) is therefore an important component of environmental operations at these facilities to control fugitive emissions.

Sources of leaks include valves, flanges and other connections, pumps and compressors, pressure relief devices, process drains, open-ended valves, pump and compressor seal systems, degassing vents, accumulator vessel vents, agitator seals, access door seals, and cracks and corrosion can also lead to leakage even where there are no fittings. As one might imagine, the plumbing of such fittings in a plant or pipeline is both complex and extensive, and keeping track of the leak data for hundreds of thousands or even millions of fittings is a significant issue. In fact, in the U.S. 55% of all air emissions from refineries and 22% of emissions from non-refineries are due to fugitive volatile organic compound (VOC) emissions from leaking equipment components such as valves, flanges, compressors, connectors, and other fittings.

The US Army has invested over $122 million dollars in state of the art safety equipment such as the Automated Chemical Detector Alarm (ACADA) from SMITHS DETECTION™. Although rated as effective at alerting force personnel to the presence of dangerous chemical agents, an ACADA unit can only detect chemicals that are in its vicinity, meaning that by the time the alert is sounded, the ground personnel are already at risk of dangerous exposure.

A superior solution is a standoff Chemical Biological Threat (CBT) sensor that can identify chemical threats from a distance. One approach is the Joint Service Lightweight Standoff Chemical Agent Detector (JSLSCAD) from GOODRICH™, for which the U.S. Army has invested over $66 million. JSLSCAD has a range of up 2 km and a field of regard of 360° azimuth and −10° to +50° elevation. Even with these tools, the U.S. Army is already expressing a need for a compact, passive, next-generation imaging CBT sensor that can capture hyperspectral data from a distance and process it in-camera to produce and display an image that visually alerts the warfighter to the exact location of potential threats. Such a system also needs to be heavily ruggedized.

In refineries a portable instrument called an “EPA Method 21 monitor” is used to detect leaks from individual sources, by manually passing the monitor over all of the fittings and recording leak data for later analysis. However, recently, the EPA proposed an alternative work practice, also referred to as Smart LDAR, to address the inefficiencies and challenges associated with the past practice. Smart LDAR involves the use of infrared (IR) cameras that detect VOC plumes from components that need repair. The IR cameras more than quadruple the number of components that an operator can monitor per hour.

However, Smart LDAR is still a manual process, susceptible to operator error, can have delayed leak identification, and does not provide real-time leak notification for immediate repair. Thus, Smart LDAR leaves significant room for improvement.

The next generation of SMART LDAR was developed by Providence Engineering and allowed partial automation of the process. The LDAR3 process uses newly developed algorithms that automatically process IR images and recognize VOC plumes as leaks. The automation greatly improved the process, allowing leak inspection frequency to increase from bi-monthly to weekly or daily, thereby reducing emissions from leaks that would be undetected for longer periods under traditional or Smart LDAR. Second, because of the increased monitoring frequency, the requirement for IR cameras' detection limit can be relaxed per EPA Alternative Work Practice (AWP) protocol using Monte Carlo simulation procedures. Thirdly, the automation allows an IR camera to cover a large process area and significantly reduces the labor cost associated with leak detection.

Another SMART LDAR camera is GasFindIR,™ which utilizes infrared imager employing sensitive detector to observe active leaks of VOCs such benzene, propane, and methane. The camera has a thermal sensitivity of 100 mK at 30° C., F 2.3, and has a detector with Focal Plane Array (FPA), InSb, 320×240 pixels, Spectral range 3-5/μm. With this camera, real-time thermal images of gas leaks appear as black smoke on a small display screen. However, users must capture and record images to an off-the shelf video recorder for a permanent record, and this system allows only leak detection, not leak identification because the spectral range is limited.

Another IR system for leak detection is described in U.S. Pat. No. 5,461,477. This system uses a tunable Fabry-Perot optical filter for providing a spatially accurate wavelength-resolved image of a sample having two spatial dimensions. The optical filters include one or more order-sorting interference filters, one or more bandpass filters, or a tunable bandpass filter that can be a second tunable interferometer in order to pass only predetermined wavelengths to the detector. The filters serve to remove unwanted wavelengths, resulting in a continuous (rather than discontinuous) image. As a consequence, information is lost and/or signal intensity decreased.

Yet another system for leak detection is described in U.S. Pat. No. 6,985,233. This system also uses a tunable Fabry-Perot interferometer, where the spacing between adjacent filter elements is adjusted by a micro electro-mechanical system (“MEMS”) actuator. Further, the system employs a series of wedge shaped or stepped filter elements, which allow different positions on the tunable filter area to be tuned to different wavelengths at the same time. As above, the system uses a continuous, rather than discontinuous images.

What is needed is a cost effective, easy to implement system for both leak detection and localization that allows automatic and easy correlation of data to location, time, and leak characteristics, but that also provides for gas identification on real-time (or nearly real-time) scale. Ideally, the system would be portable and have long battery life and be rugged enough for field use.

### SUMMARY OF THE INVENTION

We present herein a system for imaging leaks with a technology that is handheld, battery powered and allows leak detection, measurement of the rate of leakage, and gas identification on a time scale of just a few seconds. In preferred embodiments, the system also allows leak localization by determination of GPS coordinates at the time of leak detection and/or identification.

In one embodiment, the invention comprises an apparatus for sensing leaks in a pipeline, which comprises temperature sensing means for determining temperature along the exterior of the pipeline; location sensing means for determining the location of said temperature sensing means, communication means for transmitting temperature and location data to a processing unit which can be separate or part of the camera system; processing means for determining where the temperature of the exterior of the pipeline differs by at least a predetermined amount from the temperature of the exterior of the pipeline at adjacent locations along it and for classifying such temperature difference as a “leak,” for determining the flow rate of said leak, for associating each such leak with a unique location, and for identification of the content of a leak by its spectral signature. Finally, the system comprises display means for displaying said leak, rate, location, identification, etc. data in real time, and may also comprise recording means for creating a permanent or semi-permanent record of all information collected.

Generally speaking, the invention employs a hyper-spectral imaging (sometimes used interchangeably with imaging spectroscopy) system that uses a scanning etalon and successive frames to measure and detect the absorption/emission spectra of a hydrocarbon species. The algorithms that are required to perform this detection are embedded in a long wavelength infrared camera system. However, unlike the prior art systems, bandpass filters are omitted, and the resulting discontinuous images are deconvolved into a single image using deconvolution algorithms. The system improves sensitivity and yet is light weight and rugged. The omission of filters allows for less expense and smaller size and cost.

In preferred embodiments, the instrument has two modes of operation: First, a “Detect Mode” having about 0.5 micron spectral sampling resolution, and second, an “Identify Mode” having about 0.1-0.25 micron spectral sampling resolution. The two mode system allows very fast detection of leaks in the detect mode, and the increased resolution in the identify mode allows accurate collection of chemical spectra and thus identification of the leaking gas.

Leaking gas will usually be hydrocarbon species with characteristic absorption bands in the 7.5-14 micron long wavelength IR (“LWIR”). The absorption/emission spectra of these gasses is well known in the literature and is well described in J. Coates, Interpretation Of Infrared Spectra, A Practical Approach, in ENCYCLOPEDIA OF ANALYTICAL CHEMIS1RY, R. A. Meyers (Ed.), p. 10815-10837 (John Wiley & Sons Ltd, 2000). Thus, the spectral range should be at least about 7-15 microns, and preferably 5-20 or 3-21 microns.

The system is programmed to capture and record the initial temperature of the gas, the ambient temperature of the surroundings, and the extent of the gas-plume and its increase with time. From this information, the flow-rate of the gas from the leak can also be calculated. Preferably, the system at least meets EPA standards for Method 21 measurements.

In one embodiment, the system is also programmed to capture and record GPS coordinates when a leak is detected, the operator moving closer if needed for accurate localization.

The system will provide a real-time 2D image of a scene in the LWIR with the gas-plume identified in the image. The image can be in black and white, as is now provided in available IR camera's, but it is also possible to computer colorize the information according to known algorithms, and make the much more distinct, by making for example, a hot plume red against a blue or green ambient background.

In preferred embodiments, the camera wirelessly transmits data to a nearby video or other data recorder, but in preferred embodiments, the data recordation can be an onboard system.

Additional system preferences include:
Minimum pixel count: about 120×160 pixels
Field-of-view: Adjustable between 5 degrees and 30 degrees
Hand-held
Able to pass intrinsic-safety requirements
Capable of operating with video recording for 8-hours on a single battery charge
Capable of providing a wireless data-stream

In preferred embodiments, the invention is a hand held system that collects and records leak detection and localization data, comprising an IR camera with a GPS locator and wireless ports that allow real time communication with a hand held computer configured to record and analyze data, thus providing real time leak detection and localization information. The data can also be downloaded to a standalone or networked computer for later use, such as emissions calculations and inspection verification. In other embodiments, the system processing hardware and software, or portions thereof, are provided on the camera itself.

In another preferred embodiment, the IR camera is a light-weight, compact, rugged hyperspectral imager which we have termed a Super Resolution Hyperspectral Etalon Imaging System (SRHE-IS). The camera is based on two enabling technologies. The SRHE-IS uses the newly commercialized class of microbolometer infrared (IR) cameras, that are considerably cheaper and more compact than their cryogenically cooled predecessors. The key technology innovation, though, is the proposed Super Resolution Hyperspectral Etalon (SRHE), which is described technically below. A conceptual image of the instrument in use is shown in FIG. 3. The SRHE-IS measures the IR signature of every pixel in the display and alerts the user of spectra that correlate to known hydrocarbons. Our proposed instrument addresses the challenges of this topic in the following key ways:
Remote detection of chemical and biological threat agents
Compact, hand-held size: 6″×6″×8″
Light-weight: 5 lbs
Ruggedized and vibration-proof
Fast data processing (no Fourier transforms!)
Super-resolution of 0.1 μm (60 cm-1)
Real-time video
Sub-aperture spectral analysis of specific regions of interest
Flat spectral response over full spectral range of interest
No cryogenic cooling
Inexpensive commercially-available components
Anticipated cost <$20,000/unit

The invention is also directed to a method for locating a leak in a pipeline, which comprises: passing a hand held temperature sensing means over all pipelines that are to be inspected for leaks, sensing both thermal events that occur in proximity to the pipeline and the location of the temperature sensing means at each moment in time, automatically determining in real time where the temperature differs from the locations adjacent to it by a predetermined amount and classifying said temperature difference as a “leak,” associating each leak event with a location, and outputting the leak information on a display in real time. Then, the method comprises switching to identify mode, wherein a high resolution spectra of the leak is taken and the spectral signature compared with the predetermined signatures of known gases, thus allowing identification of the leaking chemical. The leak, location, rate and identification data can be stored in a form for later retrieval and use and/or can be displayed for immediate operator use.

For cost effectiveness and ease of use, the camera should be small enough to easily carry and should have sufficient sensitivity to be suitable for VOC detection. Generally, the camera has a tunable Fabry-Perot interferometer placed inline with a IR Focal Plane Array (FPA). Fabry-Perot interferometer is adjustable using any tuning means, but preferably with a piezo-driven microfocusing/scanning device that can move the mirrors of the interferometer 20 microns in 200 ms with a 50 g load. In a preferred embodiment, the tunable etalon uses piezoelectric stack actuators to adjust the cavity width, flexures to provide tension, and capacitive sensors to measure the thickness of the cavity.

No bandpass filters are required, instead the images are deconvolved using known algorithms, and preferably using matrix multiplication—a sequence of multiplication and addition steps that is optimally coded for speed. Matrix multiplication and addition are well known mathematical techniques, and several algorithms are known for multiplying matrixes (e.g, Strassen's algorithm, Coppersmith-Winograd algorithm, and the subequent modifications by Cohn).

The FPA can be any commercially available IR FPA having a thermal sensitivity of less than 100 mK at 30° C., preferably <80 mK at 30° C. Modem FPAs are available with up to 2048×2048 pixels, and larger sizes are in development by multiple manufacturers. However, smaller arrays of about 320×256 and 640×480 arrays are available and more affordable and a minimum of 120×120 is required. Preferably, the FPA is uncooled, thus further reducing cost, weight and power needs. Uncooled FPAs can be based on pyroelectric and ferroelectric materials or microbolometer technology. Preferably, the FPA can detect (see) the common fugitive leak hydrocarbons at a minimum of 10,000 ppmv, and more preferably at <1000 ppmv.

Infrared-sensitive materials commonly used in IR detector arrays include mercury-cadmium-telluride (HgCdTe, “MerCad”, or “MerCadTel”), Indium Antimonide (InSb, pronounced “Inns-Bee”), Indium Gallium Arsenide (InGaAs, pronounced “InnGas”), and Vanadium Oxide (Vax, pronounced “Vox”). A variety of lead salts can also be used, but are less common today. In preferred embodiments, the FPA is an InSb with 320×240 pixels.

The lens can be any commercially available lens. Further, the lens can be interchangeable, allowing various lens to be used depending on the application and different fields of view required for different applications: e.g., 25 mm (22°), 50 mm (11°), 100 mm (5.5°).

Preferably, the power consumption is <6 W so that the system can be powered with a battery having a life of at least 8 hours. Preferably the battery is rechargeable in a few hours. Lithium or lithium ion batteries are preferred.

The system hardware can be any hardware sufficient to run the software in a reasonable time period, including external computers (particularly in the proof of concept stage), but onboard dedicated computers may be designed and employed in future models.

The software can be any suitable software or can be specially coded for optimization of speed. Included are MATLAB, Mathematica, FRED, Zemax, and Inventor.

Further quantitative processing of these video image data or automatic recognition of VOC plumes can be hindered by unaligned video frames owing to the slight vibrations of the camera. Therefore, in a preferred embodiment, an automatic method is used to align the IR video frames as a preprocessing procedure for other possible video processing methods. The alignment method is based on a two-dimensional spatial Fourier transform. The accuracy can reach fractional pixels in estimation of translational shift and 1-20 for rotational shift. Temporal Fourier transform of actual industrial tests of IR videos is performed with both unaligned and aligned video frames. The results indicate that after the alignment of the video frames, the camera motion interferences on VOC plume identification can be eliminated or minimized, and the VOC plume can be identified through investigating the characteristic flickering frequency power in the temporal Fourier transform. This alignment method provides a useful tool for IR or other optical video image data preprocessing purposes.

### BRIEF DESCRIPTION OF THE DRAWINGS

FIG. 1. Basic configuration for the tunable Fabry-Perot etalon-based imaging IR Camera.

FIG. 2. Conceptual illustration of Super Resolution Hyperspectral Etalon Imaging System (“SRHE-IS”) operational process chain.

FIG. 3. Conceptual design of SRHE-IS.

FIG. 4. Conceptual design of etalon for SRHE-IS.

FIG. 5. Illustration of Fabry-Perot etalon.

FIG. 6. Transmission peaks of an etalon for cavity widths of (a) 5.5 μm and (b) 11 μm.

FIG. 7. SRHE-IS transmission vectors for wavelength of (a) 8.5 μm and (b) 8.6 μm.

FIG. 8. Matrix of transmission vectors.

FIG. 9. Simulated recovery of a random spectrum using preliminary mathematical model of SRHE-IS.

FIG. 10. Conceptual illustration of the relationships among threat detection, discrimination, quantification, classification, and identification.

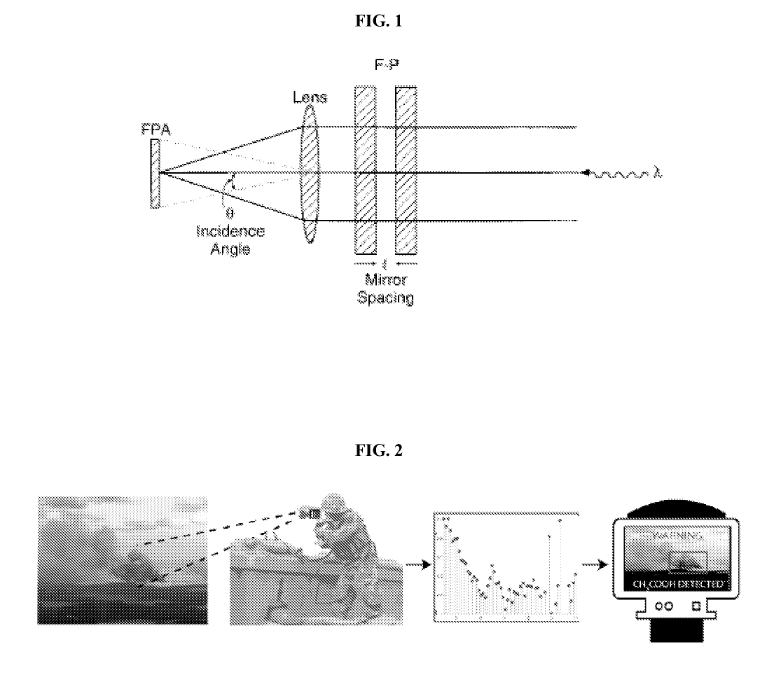

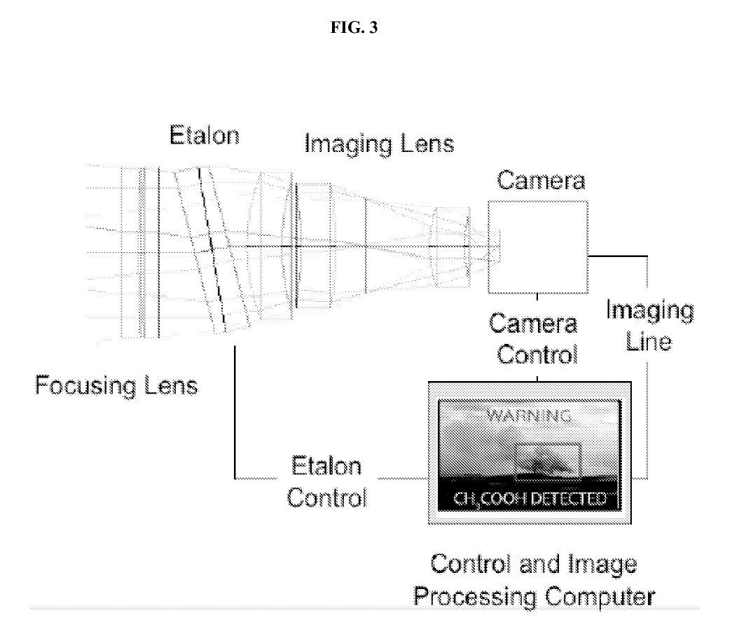

### DESCRIPTION OF EMBODIMENTS OF THE INVENTION

The following description illustrates certain preferred embodiments and is not to be used to improperly limit the scope of the invention, which may have other equally effective and/or legally equivalent embodiments.

### Example 1

### SHRE-IS

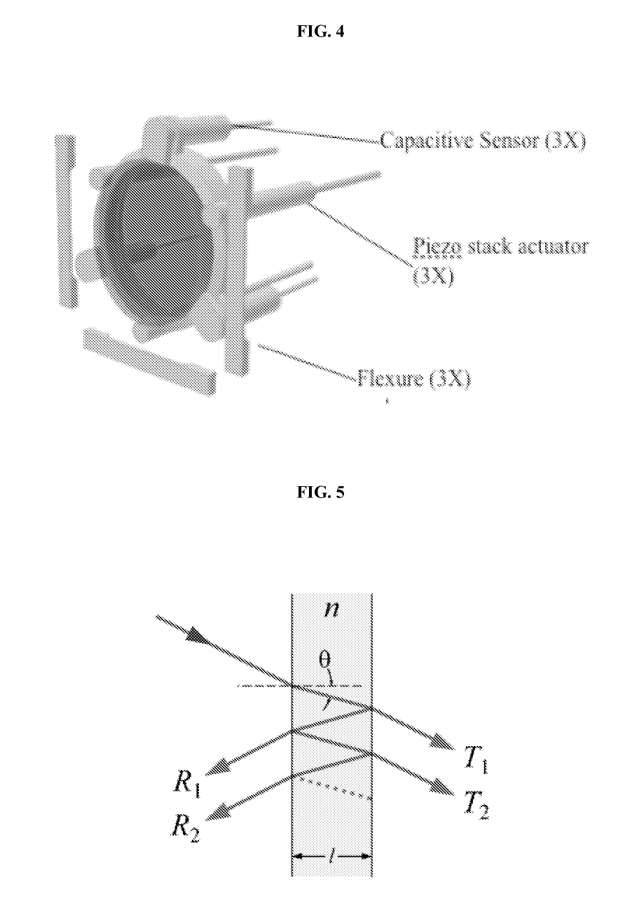

A conceptual drawing of the SRHE-IS is shown in FIG. 4. The system consists of a Fabry-Perot etalon, an imaging lens, a microbolometer camera, and a computer for spectral and image data post-processing. The proof-of-concept prototype to be built at the beginning of Phase II will use a separate computer for data processing, but future iterations of the design will move the processing to on-board processors within the camera. Our technical approach combines the commercial promise of new low-cost microbolometer cameras with an innovative method to extract super-resolution spectral data from a Fabry-Perot etalon. During the Phase I Option we will investigate existing algorithms for identifying and tagging IR signatures. The SRHE-IS will be lighter, cheaper, and more rugged than existing hyperspectral imaging systems.

Microbolometer Camera: Coming out of Honeywell in the mid 1980's, a microbolometer responds to thermal changes by producing a corresponding change in its electrical resistance. Detecting the resistance change allows temperature to be calculated at each pixel, and this leads to the formation of a thermal image. The primary advantage of a microbolometer array is that it does not require the cryogenic cooling used by other thermal cameras. Microbolometer cameras are sensitive in the 8-13 μm spectrum, are small and lightweight, have low power consumption, and have a relatively low cost. Modem microbolometer detectors can produce VGA size images at video rates with better than 50 mK thermal sensitivity. A number of well established companies, such as FUR, BAE Systems, and Fluke, are licensed to sell microbolometer based thermal sensor devices.

Super Resolution Hyperspectral Etalon(SRHE): Fabry-Perot etalons are a class of tunable optical filters that are compact and light-weight, and can be designed to be very vibration insensitive. As such etalons are an excellent choice for instruments that need to be ruggedized. Our conceptual design for such an etalon is shown in FIG. 5. The proposed tunable etalon will use a piezoelectric stack actuators to adjust the cavity width, flexures to provide tension, and capacitive sensors to measure the thickness of the cavity. ASE has developed a method to improve the spectral resolution of an etalon by nearly a full order of magnitude beyond their standard resolution, making them better suited for hyperspectral imaging. We will begin with a very brief review of etalon technology then describe our innovative method to achieve super resolution by scanning the etalon beyond its usual range.

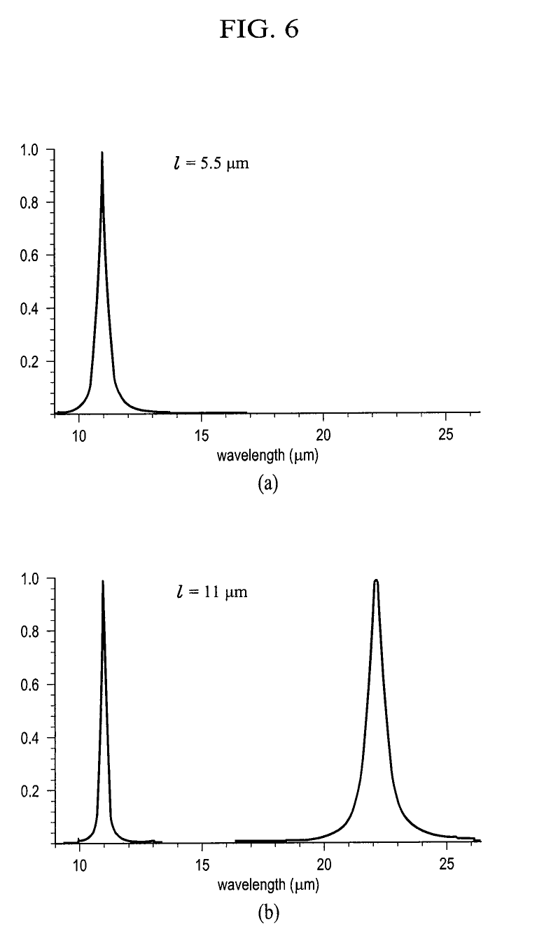

A tutorial drawing of an etalon appears above. The etalon consists of a pair of highly-reflective parallel flats separated by a small airgap. The airgap acts as a resonant cavity that transmits only wavelengths that correspond to fundamental frequencies. By adjusting the thickness of the airgap, the etalon can be tuned to transmit different wavelengths. As a concrete example, we will consider an etalon with mirrors that transmit 10% of the light incident upon them, and reflect 90%, and we will consider the spectral range from 8.5 μm to 14 μm. If the etalon cavity thickness were set to 1=5.5 μm, then the etalon would transmit the first order transmission peak of the etalon λ=11 μm. If the etalon is expanded, the first-order transmission peak will move toward longer wavelengths until, at 1=11 μm, the first order transmission peak will occur at, λ=22 μm and the second order peak will appear at λ=11 μm. This is illustrated in FIG. 6. The distance between the first and second peak is called the “free spectral range” or FSR of the etalon. This is generally used as the scan limit for the etalon.

The other important physical limit of the etalon is the peak width. The peak width depends in a rather complicated fashion on the reflectivity and width of the etalon cavity, but for the etalon we are studying, the width of the first order peak is approximately 0.5 μm, as can be seen in the figure. To summarize, the Fabry-Perot etalon we are discussing, when used conventionally, is limited to a free spectral range of 5.5 μm and a resolution of 0.5 μm.

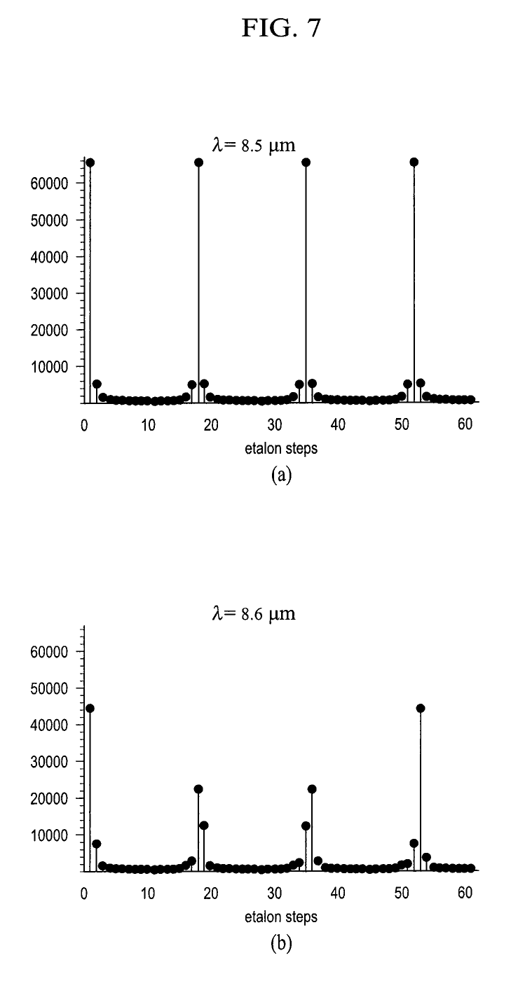

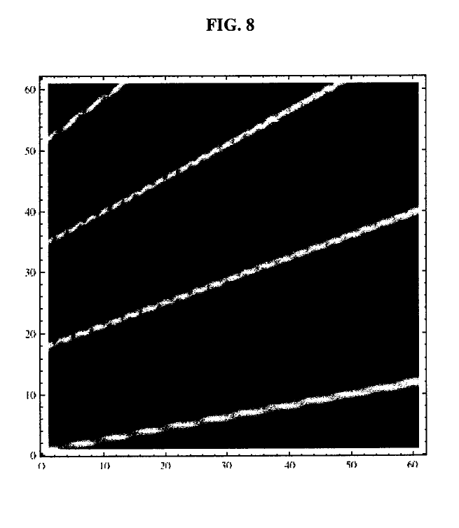

We will now present an innovative method to achieve super-resolution using the same etalon. This is done by scanning the etalon far beyond the typical free spectral range and then processing the data using a simple and fast matrix multiplication. In particular, we will scan the etalon cavity 15 μm, from 4.25 μm to 19.25 μm, using 61 evenly spaced steps of 0.25 μm. We refer to this as multi-FSR scanning. By scanning over such a large range, up to four orders of transmission peaks will traverse the spectral range of interest. FIG. 7 shows the signal detected by the camera for two different spectral ranges, 8.5 μm and 8.6 μm. We will refer to these data sets as transmission vectors. Even though the wavelengths are separated by only 0.1 μm, the transmission vectors for the two wavelengths are quite different. In fact, if the spectral range is divided into 61 evenly spaced sections, it can be shown that each vector is unique and linearly independent. A plot of all of the transmission vectors organized side by side as a 61×61 matrix is shown in FIG. 8.

Because the vectors composing this matrix are linearly independent, the matrix is invertible, thus it is possible to extract the incident spectrum from the transmission vector. It is important to note that the inverse matrix used for the extraction is a numeric constant calculated during camera wavelength calibration. During use the camera DOES NOT perform matrix inversion calculations (which are computationally intensive). Instead the camera performs matrix multiplication; these are simply a sequence of multiplication and addition steps and can be optimally coded for speed.

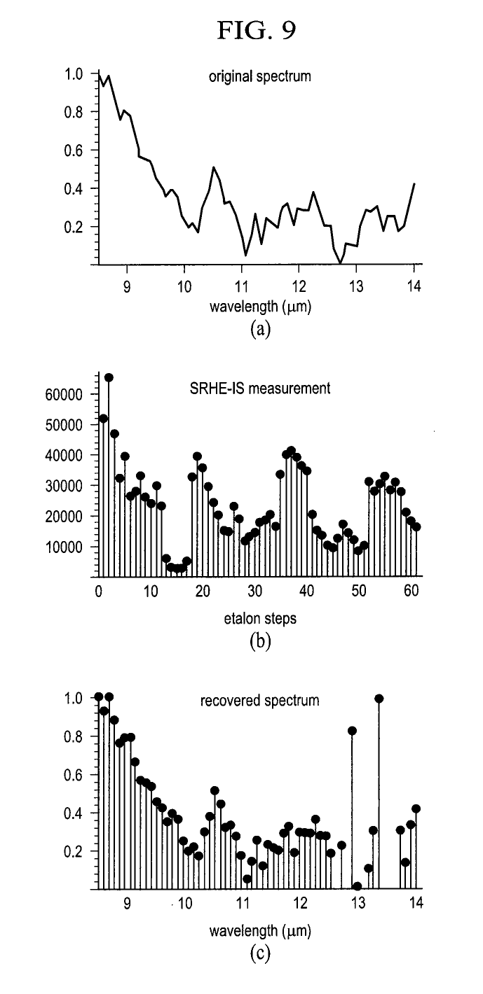

As a first proof of principle we have developed a simple example that shows that the process described above results in resolution five times as narrow as one would expect using the etalon in a standard manner. The spectrum recovery process is illustrated in FIG. 9. The spectrum in FIG. 9(a) is a random-walk spectrum. In FIG. 9(b) we calculate the transmission vector that a SRHE-IS would measure for the example spectrum. Although the measured transmission vector data looks nothing like the original spectrum, by multiplying the transmission vector by the inverse of the matrix shown in FIG. 8, we recover the spectrum shown in FIG. 9(c). The recovery for the lower wavelengths is excellent, with an RMS deviation from the original spectrum of only 1%, although there are clearly some problems recovering data for wavelengths longer than 12.4 μm. We believe that accurate recovery at longer wavelengths can be achieved by increasing the multi-FSR scan range. For this simulation, only the first and second order peaks scanned over the entire wavelength range, while the lower wavelengths were also scanned by the third and fourth order peaks, which are considerably narrower. Studying the effects of scan range and step size on spectrum recovery will be a principal task of the Phase I research.

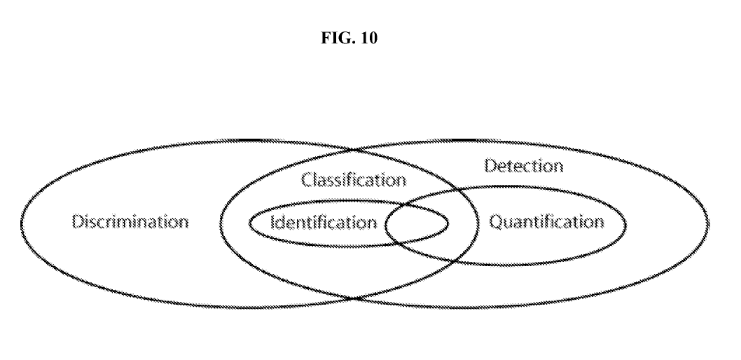

The application of hyperspectral data to threat identification requires the threat to be detected, discriminated from the background, and classified before identification can be made. The relationship among these tasks is illustrated in FIG. 10. Although the field of automated recognition using hyperspectral imaging is still an active area of research,^{1,2,3} the technology is quite mature. A number of books dealing with hyperspectral image analysis have been published,^{4,5,6,} and a number of commercial software packages exist that allow the end user to process hyperspectral image data, specifically products from ITT, Clark Labs, Applied Analysis, Inc., and SpecTIR. During Phase I we will focus our efforts on demonstrating the technical feasibility of SRHE-IS, with an eye toward making our new instrument compatible with existing threat recognition technology. During the Phase I Option we will determine which of the many solutions seems to be best matched to our device.

In conclusion, the present invention and the embodiments disclosed herein are well adapted to carry out the objectives and obtain the ends set forth. It is realized that changes are possible within the scope of this invention, and it is further intended that each element or step recited is to be understood as referring to all equivalent elements or steps. The description is intended to cover the invention as broadly as legally possible in whatever forms it may be utilized.

All references cited herein are expressly incorporated by reference.

1. Ren, Hsuan and Chang, Chein-1. Automatic spectral target recognition in hyperspectral imagery, Aerospace and Electronic Systems, IEEE Trans., 39: 4, 2003, pp. 1232-1249.

2. Sameh M. Yamany, Aly A. Farag and Shin-Yi Hs. A fuzzy hyperspectral classifier for automatic target recognition (ATR) systems, Pattern Recognition Letters, 20, 1999, pp. 1431-1438.

3. Prasad, S., Bruce, L. M. Decision Fusion With Confidence-Based Weight Assignment for Hyperspectral Target Recognition, Geoscience and Remote Sensing, IEEE Trans., 46: 5, 2008, pp. 1448-1456

4. Hyperspectral Imaging: Techniques for Spectral Detection and Classification. Chang, Chein-1. 2003

5. Hyperspectral Remote Sensing: Principals and Applications. Borengasser, M., Hungate, W. S., Watkins, R. 2007

6. Hyperspectral Data Exploitation. Chang, Chein-I, 2007

7. U.S. Pat. No. 5,461,477, U.S. Pat. No. 6,985,233.

We claim:

1. A leak detection and localization system, comprising:
a lens for collecting radiation,
a Fabry-Perot interferometer in line with said radiation, and a focusing means for adjusting the said Fabry-Perot interferometer;
an uncooled focal plane array (FPA) inline with said radiation for detecting the temperature of said radiation, said focal plane array having a sensitivity of <100 mK at 30° C., at least 120×120 pixels, and a spectral range of at least 5-14 microns;
said system including a processor operably connected to said FPA for deconvoluting a discontinuous image to a continuous image and converting said continuous image into a 2D representation of temperature; and
display means for displaying 2d temperature data in near real time.

2. The leak detection and localization system of claim 1, wherein the FPA is a microbolometer.

3. The leak detection and localization system of claim 1, wherein the processor does not use Fourier transform for said deconvoluting.

4. The leak detection and localization system of claim 1, wherein the processor uses matrix multiplication for said deconvoluting.

5. The leak detection and localization system of claim 1, wherein the resolution of said system is 0.1 μm.

6. The leak detection and localization system of claim 1, wherein the system scans the etalon cavity from 4.25 μm to 19.25 μm, using 61 evenly spaced steps of 0.25 μm.

7. The leak detection and localization system of claim 1, wherein the system does not employ bandpass filters.
